(19) United States
(12) Patent Application Publication
(10) Pub. No.: US 2023/0211526 A1
(43) Pub. Date: Jul. 6, 2023

(54) TOOLING FORMED FROM A 3D PRINTED TOOLING SCAFFOLD

(71) Applicant: ESSENTIUM, INC., Pflugerville, TX (US)

(72) Inventors: Charles Brandon Sweeney, Pflugerville, TX (US); Thomas Mulholland, Austin, TX (US); Luke Johnson, Austin, TX (US); Bryan Zahner, Pflugerville, TX (US); Nirup Nagabandi, Pflugerville, TX (US)

(21) Appl. No.: 18/001,152

(22) PCT Filed: Jun. 7, 2021
(86) PCT No.: PCT/US21/36150

§ 371 Date: Dec. 8, 2022

Related U.S. Application Data
(60) Provisional application No. 63/036,707, filed on Jun. 9, 2020.

(51) Int. Cl. B29C 33/38; B29C 33/58; B29C 33/06

(52) U.S. Cl. CPC B29C 33/3842; B29C 33/58; B29C 33/06; B33Y 10/00

(57) ABSTRACT

Tooling formed from a 3D printed scaffold includes a 3D printed scaffold a casting material hardened within the scaffold; and a forming surface defined by the scaffold. A method forming the tooling includes 3D printing a tooling scaffold, wherein the scaffold defines a void volume and a forming surface, filling the void volume with casting material, and hardening the casting material.

### CROSS-REFERENCE TO RELATED APPLICATIONS

The present application claims the benefit of the filing date of U.S. Provisional Application 63/036,707, filed on Jun. 9, 2020, and incorporates the teaching herein by reference.

### FIELD

The present disclosure is directed to tooling formed from a 3D printing tooling scaffold and, particularly, to cast tooling from material extrusion 3D printed scaffolds and a process of forming cast tooling from material extrusion 3D printed scaffolds.

### INTRODUCTION

Tooling is used to form parts out of polymer or metal in processes such as injection molding, blow-molding, compression molding, extrusion, vacuum forming, hydroforming, and casting. Tooling typically includes a forming surface, such as a hollowed-out cavity that is a negative form of the part or a raised surface that is a positive form of the part. Tooling is often machined from metal blocks or formed out of wood. Tooling can be simple or complicated, depending on the process in which the tooling is used. For example, in injection molding, tooling may require ejector systems, sprue bushings, cooling lines, moving cores or other features. Increasing complexity increases expense as does the materials and time needed to manufacture the tooling. During part development cycles and in making prototype tooling and parts, the expense of forming a tool for each iteration of the part may be cost prohibitive and the time needed for adjusting the tooling may extend part development cycles.

To address tooling development and product cycle time issues, tooling is sometimes formed by additive manufacturing, where the tooling is formed from a polymer material printed by high speed extrusion, fused deposition modeling, laser sintering, stereolithography, material jetting, and other methods. However, in some applications, these tools may not be mechanically, thermally, or chemically robust enough for the number of molding cycles needed to form enough parts for testing. In addition, additive manufacturing feedstock materials are relatively expensive, and depending on the size and density of the tooling, the tooling may still take days to form. Also, tooling formed by additive manufacturing, in some instances, is not watertight under pressure and additional treatment may be necessary to seal cooling channels and forming surfaces.

While the current tooling processes achieve their intended purpose, there is a need for new and improved tool making methods and tools made by such methods for use in molding parts from formable substances.

### SUMMARY

According to various aspects, the present disclosure relates to a method forming tooling. The method includes 3D printing a tooling scaffold, wherein the scaffold defines a void volume and a forming surface. The method further includes filling the void volume with casting material and hardening the casting material.

In aspects of the above, the method further includes treating the tooling scaffold prior to filling the void volume with casting material. In aspects, treating the tooling scaffold includes machining the tooling scaffold. In additional or alternative aspects, treating the tooling scaffold includes coating a release agent on the tooling scaffold.

In any of the above aspects, the method further includes applying a magnetic or electrostatic field to the tooling scaffold while filling the void volume with casting material.

In any of the above aspects, the method further includes vibrating the tooling scaffold after filling the void volume with casting material.

In any of the above aspects, the void volume is filled with casting material using a casting method selected from the group consisting of vibration casting, vacuum casting, pressure casting, and centrifugal casting.

In any of the above aspects, hardening the casting material comprises chemically reacting the casting material. In some aspects, the casting material is concrete and chemically reacting the casting material includes hydration. In some aspects, the casting material includes a thermoset and chemically reacting the casting material includes crosslinking the casting material. In some aspects, chemically reacting the casting material includes vulcanization of the casting material.

In any of the above aspects, the method further includes removing the tooling scaffold from the casting material after hardening.

In any of the above aspects, the scaffold further defines cooling lines and the method further comprises introducing cooling or heating fluids or gasses into the cooling lines while hardening the casting material.

In any of the above aspects, the scaffold further defines cooling lines and the method further comprises sealing the cooling lines.

In any of the above aspects, the method includes sealing the forming surface.

In any of the above aspects, the method includes generating a computer numerical control code from a CAD file, wherein the computer numerical control code is used in 3D printing a tooling scaffold. In some aspects, the method further includes merging a plurality of CAD files for generating the computer numerical control code.

According to various aspects, the present disclosure relates tooling formed from a 3D printing scaffold. The tooling includes a 3D printed scaffold, a casting material hardened within the scaffold, and a forming surface defined by the scaffold. In aspects, the tooling is formed according to the above described aspects of a method forming tooling.

In any of the above aspects, the tooling further comprising an auxiliary feature defined by the 3D printing scaffold, wherein the auxiliary feature includes cooling lines.

In any of the above aspects, the 3D printed tooling scaffold includes a plurality of baffles.

### BRIEF DESCRIPTION OF THE DRAWINGS

The drawings described herein are for illustration purposes only and are not intended to limit the scope of the present disclosure in any way.

FIG. 1 illustrates a flowchart of a method of forming cast tooling using 3D printed tooling scaffolds according to an exemplary embodiment of the present disclosure;

FIG. 2A illustrates tooling and, in particular, half of a tooling base including a forming surface provided as a cavity in the tooling base according to an exemplary embodiment;

FIG. 2B illustrates a cross-section of FIG. 2A;

FIG. 3A illustrates a tooling scaffold for forming the tooling exhibited in FIG. 2A according to an exemplary embodiment;

FIG. 3B illustrates a cross-section of FIG. 3A;

FIG. 3C illustrates a three-dimensional digital representation of the tooling scaffold of FIG. 3A;

FIG. 4 illustrates a cross-section of a printed tooling scaffold, such as a cross-section of FIG. 3A, according to an exemplary embodiment;

FIG. 5 illustrates cast tooling including a tooling scaffold including casting material according to an exemplary embodiment; and

FIG. 6 illustrates cast tooling including a tooling scaffold including a casting material according to another exemplary embodiment.

### DETAILED DESCRIPTION

The following description is merely exemplary in nature and is not intended to limit the present disclosure, application, or uses. The present disclosure is directed to cast tooling from material extrusion 3D printed scaffolds and a process of forming tooling from material extrusion 3D printed scaffolds. Tooling may include fixtures, jigs, gauges, molds, dies, cutting equipment and patterns. Tooling is used to form parts out of formable substances such as polymer or metal in processes such as injection molding, blow-molding, compression molding, extrusion, vacuum forming, hydroforming, and casting. Tooling typically includes a forming surface, such as a hollowed-out cavity that is a negative form of the part or a raised surface that is a positive form of the part. In general, the process includes forming a tooling scaffold utilizing material extrusion, and in aspects 3D printing, and filling the tooling scaffold to cast the tooling. The cast tooling is, in optional aspects, finished using at least one of the following processes: removing the scaffolding, machining, coating, plating, and polishing. The cast tooling may then be used to form parts from materials such as polymers or metals through molding processes including injection molding, blow-molding, compression molding, roto-molding, composite lay-up, extrusion, vacuum forming, hydroforming, and casting.

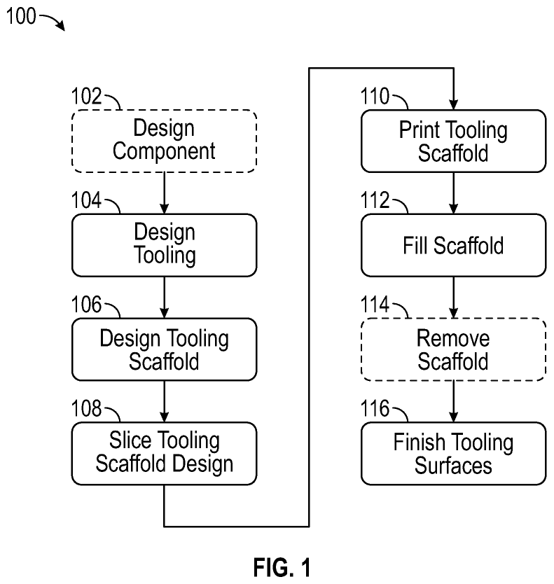

References is now made to FIG. 1, which illustrates an aspect of a method 100 of forming a cast tooling from a tooling scaffold. The method 100 optionally begins with executing computer code to design the part to be formed by the tooling at block 102. In aspects, the part design is created by executing computer aided simulation (CAD) software or scanning apart with a 3D scanner, which is then rendered to form an electronic representation of the part.

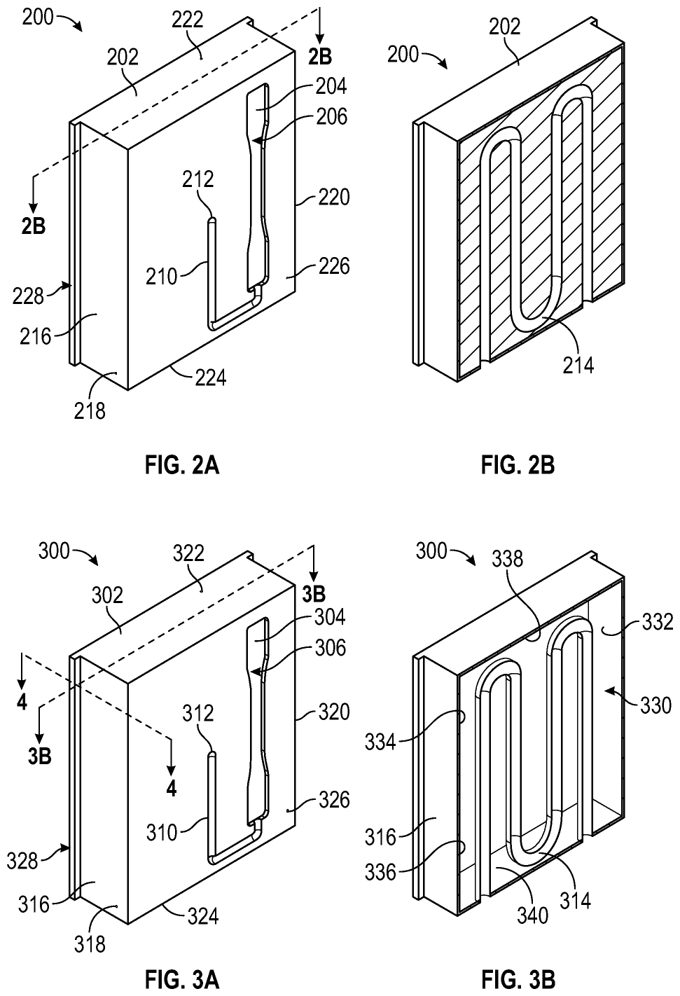

At block 104, and with reference to FIG. 2A and 2B illustrating an aspect of tooling 200, the tooling features are designed through the execution of computer code, which again may be computer aided simulation (CAD) software or other design software. In aspects, the tooling 200 features are designed as a negative of the part to be formed with the tooling 200. In other aspects, the tooling 200 features are designed as a positive of the part to be formed with the tooling 200. The tooling 200 illustrated in FIG. 2A includes a tool base 202, which is understood herein as the unit that retains, aligns, and supports the forming surface and auxiliary components such as cooling lines, electrical components, hydraulic components, and mechanical mechanisms of the tooling 200.

Only half of the tool base 202, a single plate, is illustrated in FIGS. 2A and 2B; another half of the tool base 202 is not shown, but includes similar features as the first half, such as cooling lines (described further herein) and, in some aspects, another forming surface. In addition, each half may have more than one plate, depending on the mechanical requirements of the molding process, as well as the complexity of the tooling and part to be formed. In some aspects, three plate are provided and as many as ten plates may be provided, including wear plates, clamp plates, support plates, ejector plates, etc.

A forming surface 204 is provided in the tool base 202. The forming surface is understood herein as the surface(s) that are used to shape a part. In the illustrated aspect, the forming surface 204 defines a cavity 206, or a negative mold, that is in the shape of a standard tensile test bar, often referred to as a dog bone. In addition, the tool base 202 includes several auxiliary features. In the aspect illustrated in FIG. 2A, a runner 210, formed into the tool base 202, connects the cavity 206 with an injection point 212 for introducing a formable substance, such as a polymer, into the cavity 206 and onto the forming surface 204. Furthermore, as illustrated in FIG. 2B, cooling lines 214 are provided within the tool base 202. Other auxiliary features that may be incorporated into the tooling 200, but are not illustrated, include vents, openings in the cavity 206 and tool base 202 for an ejector system, additional injection points, cores, etc. It may be appreciated that the tool base 202, the features of the forming surface 204, and the auxiliary features, including the cooling lines 214, runner 210, injection point 212, etc., maybe designed in one or more CAD files. If designed in multiple CAD files, the features maybe merged into a single CAD file before proceeding. It should also be appreciated that the tool base 202 includes an outer perimeter 216 defined by a number of exterior surfaces 218, 220, 222, 224, 226, 228. The outer perimeter 216 defines a total volume of the tool base 202 in which the various features (forming surface 204, runner 210, injection point 212, and cooling lines 214, etc.) of the tooling 200 are formed.

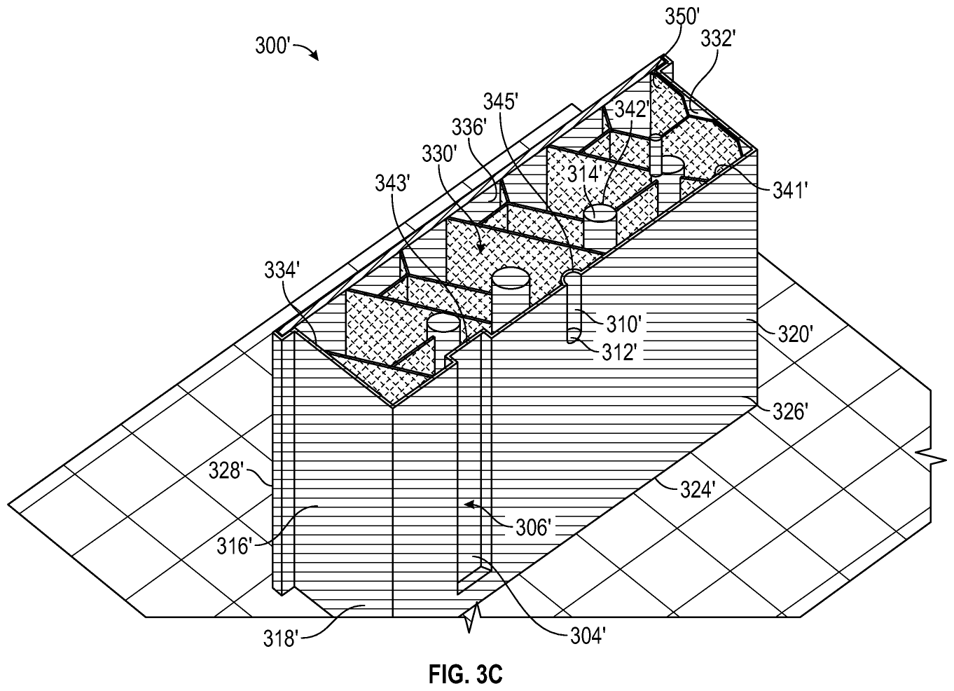

At block 106 illustrated in FIG. 1, and with reference to FIGS. 2A, 2B, 3A and 3B, the tooling scaffold 300 is created. It should be appreciated that the tooling scaffold 300 may be derived directly from the tooling 200 design described above, or the tooling scaffold 300 may be designed through the execution of CAD code without reference to a tooling 200 design. The tooling scaffold 300 is designed to define the surface features of the tooling 200 including the outer perimeter 216 and the forming surface 204, as well as the auxiliary features such as the runner 210, injection point 212, cooling lines 214, etc.

FIGS. 3A and 3B illustrate an aspect of a tooling scaffold 300, which may be used to form tooling 200 illustrated in FIGS. 2A and 2B. The tooling scaffold 300 may be a positive or negative mold of the tooling 200, depending on whether the tooling scaffold 300 will be retained as part of the tooling 200 or removed from the tooling 200. In the illustrated aspect, the tooling scaffold 300 is retained as a part of the tooling 200.

The tooling scaffold 300 includes a scaffold forming surface 304 defining a scaffold cavity 306, which provides the forming surface 204 and cavity 206 of the tooling 200. In addition, the tooling scaffold 300 defines the auxiliary features including a scaffold runner 310, a scaffold injection point 312, and scaffold cooling lines 314, which provide the tooling runner 210, injection point 212, and cooling lines 214 of the tooling 200. The tooling scaffold 300 also defines a scaffold outer perimeter 316, which forms the outer perimeter 216 of the tooling 200. The scaffold outer perimeter 316 of the tooling scaffold 300 is defined by a number of exterior surfaces 318, 320, 322, 324, 326, 328, which form the exterior surfaces 218, 220, 222, 224, 226, 228 of the tool base 202.

In addition, the tooling scaffold 300 defines a void volume 330. The void volume 330 is defined by a number of inner surfaces including inner surfaces 332, 334, 336, 338, 340 as well as the features formed within the tooling scaffold 300 such as the scaffold cooling lines 314 and, while not illustrated, the inner side of the scaffold forming surface 304, scaffold runner 310, injection point 312, etc. The void volume 330 is, in aspects, in the range of 10% to 95% of the total volume defined by the outer perimeter 316 (void or filled volume) of the tooling scaffold 300, including all values and ranges therein, such as 75% to 90%, etc. Void volume is understood herein as volume within the total volume that does not include printed filament.

It should also be appreciated that in alternative aspects where the tooling scaffold 300 may be removed when forming the tooling 200, the inner surfaces 332, 334, 336, 338, 340 and features, such as the inner surfaces of the scaffold forming surface 343′ (see FIG. 3C), scaffold runner 345′ (see FIG. 3C) and scaffold injection point 312 (not illustrated), form the tooling 200 outer surfaces 218, 220, 222, 224, 226, 228 and the forming surface 204, the runner 210, the injection point 212, etc. If the tooling scaffold 300 includes scaffold cooling lines 314, regardless of whether the tooling scaffold 300 scaffold cooling lines 314 are removed, cooling lines 214 will be provided in the tooling 200.

While the design at blocks 102, 104, or 106 may initially begin as two-dimensional representations of the physical body (i.e., the part to be formed at block 102, the tooling 200 at block 104, or the tooling scaffold 300 at block 105), computer aided design software code is executed to convert the two-dimensional design into a three-dimensional design prior to conversion into a printable version of the design. At block 108, code is executed to convert the three-dimensional design of the tooling scaffold 300 into a computer numerical control (CNC) design or toolpath file, such as G-code to slice the tooling scaffold 300 design into layers and provide code executable by a 3D printer. It should further be appreciated that the tooling 200, including the tool base 202, the features of the forming surface 204, and the auxiliary features, including the cooling lines 214, runner 210, injection point 212, etc., may be designed in one or more CAD files. If designed in multiple CAD files, the features may be merged into a single CAD file before proceeding. Similarly, the tooling scaffold 300 tool base 302, and the various features including the scaffold forming surface 304 and the auxiliary features, including the scaffold cooling lines 314, scaffold runner 310, scaffold injection point 312, etc. may be provided in one or more CAD files. If designed in multiple CAD files, the features may be merged into a single file before or after converting the CAD file into computer numerical code software for printing, described further below.

FIG. 3C illustrates a three-dimensional digital, representation of the tooling scaffold 300′, prior to 3D printing. In this aspect, the three-dimensional representation of the tooling scaffold 300′, and resulting tooling scaffold 300 printed therefrom, includes scaffold forming surface 304′ providing a scaffold cavity 306′ for receiving a casting material that will be cast in the tooling scaffold 300 to form the tooling 200. In addition, the represented tooling scaffold 300′ includes a portion of the scaffold runner 310′ and the scaffold injection point 312′ as well as scaffold cooling lines 314′. Further the representative tooling scaffold 300′ includes a number of exterior surfaces 318′, 320′, 322′(not illustrated), 324′, 326′, 328′ that form the outer perimeter 316′ of the tooling scaffold 300′. The void volume 330′ is defined by inner surfaces including surfaces 332′, 334′, 336′, 338′ (not illustrated), 340′ (not visible), and 341′as well as the features formed within the tooling scaffold 300′ such as the scaffold cooling lines 342′ and, while not illustrated, the inner side 343′ of the scaffold forming surface 304, the inner side 345′ of the scaffold runner 310′, the inner side of the scaffold injection point 312′ (not visible), which form a part of the inner surface 341′, etc. This representation of the tooling scaffold 300′ also includes a number of baffles 350′, which, in aspects, provide additional structural support to the tooling scaffold 300 (see FIGS. 3A and 3B).

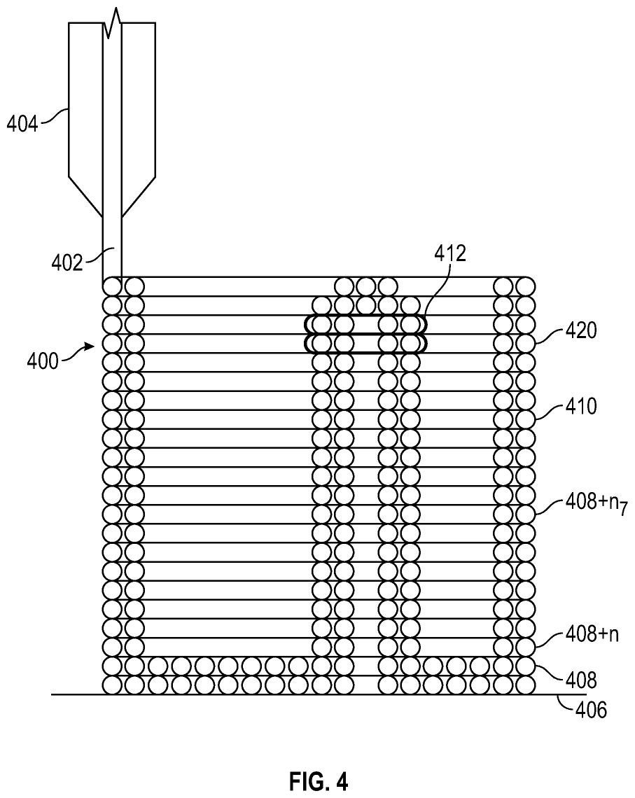

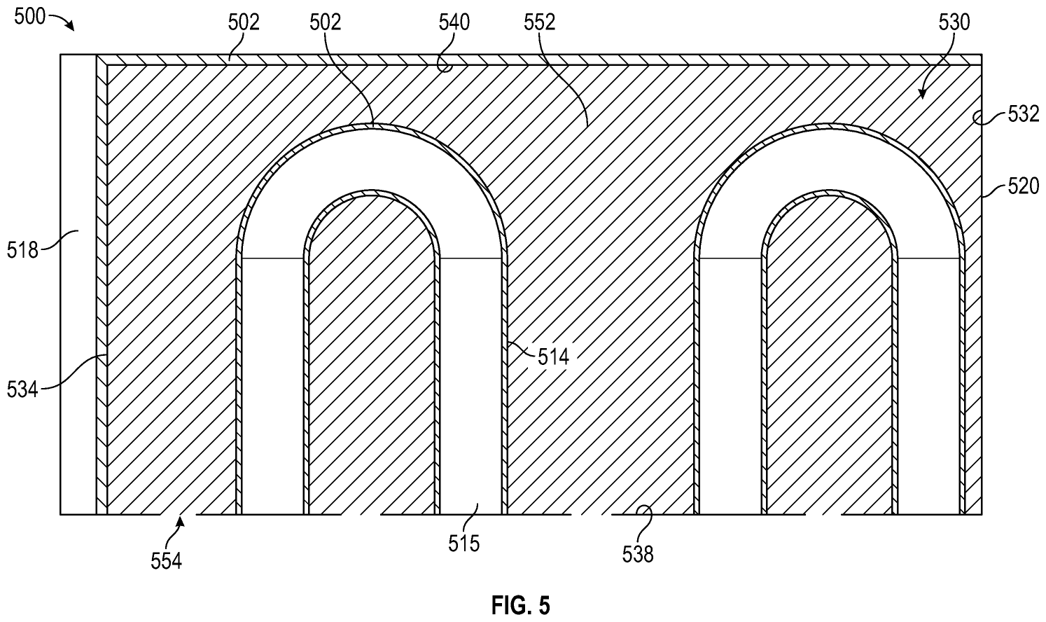

At block 110, and with reference to FIG. 4, the computer numerical control code is executed by a 3D printer to print the tooling scaffold 300. The 3D printer feeds a polymer in the shape of filament 402 into a nozzle 404 or extruder that heats the filament to the point where it begins to soften and at least partially melt at the surface. In aspects, the polymer used to print the 3D scaffold includes one or more of the following: polyester, copolyester, poly(lactic acid), polyamide, thermoplastic urethane, acrylonitrile butadiene styrene (ABS), acrylonitrile styrene acrylate (ASA), high impact polystyrene (HiPS), polypropylene, nylon (polyamide), polycarbonate, polyetherimide, fiber-reinforced polymer composites, as well as blends or copolymers thereof. In aspects, the filament polymer is selected to exhibit a softening temperature, such as a VICAT softening temperature, measured e.g., by ASTM D 1525 17e1, greater than temperatures that the tooling scaffold 400 is exposed to during the hardening of the casting material (see 552, FIG. 5), such as in the range of at least 10° C. to 100° C. degrees greater than the hardening process temperatures, and, in some aspects, up to 300° C. degrees greater than the hardening process temperature. Further, in aspects where the tooling scaffold 300 is retained in the tooling 200, the filament polymer is selected to exhibit a softening temperature, such as a VICAT softening temperature, measured e.g., by ASTM D 1525 17e1, greater than the processing temperature that the tooling scaffold 400 is exposed to when used a stooling (see tooling 500, FIG. 5), such as in the range of at least 10° C. to 100° C. degrees greater than the processing temperature and, in some aspects, up to 300° C. degrees greater than the processing temperature.

In additional aspects, the filament includes additives such as, but not limited to: fibers including carbon fiber, glass fiber, metal fibers, mineral fibers, or fibers of a different polymer having relatively higher melting points than that of the polymer forming the filament; and particles, powders or flakes including glass, metal, cellulose, mineral, carbon, or carbon nanotubes. In aspects, the additives include electromagnetic susceptible materials that heat upon the application of radio frequency including, for example, ferrous metals or carbon nanotubes in the forms described above. The fibers exhibit a particle size in the range of 1 micrometer to 100 micrometers, including all values and ranges therein and the particles, powders or flakes exhibit a size of 100 micrometers or less including all values and ranges therein, including nanoparticles having a particle length of less than 1.0 micrometer or less, including all values and ranges between 10 nanometers and 1 micrometer. Such additives, in aspects, are dispersed in the filament 402 and, in other aspects, are provided in a coating on the filament core, wherein the coating includes the same polymer or a different polymer than the filament core. The additives are present in the range of 0.1% to 90% of the total weight of the filament, including all values and ranges therein.

In further aspects, other additives are included, such as pigments, dispersants, surface modifiers, processing aids such as viscosity reducers or release agents, and flame-retardant agents, such as a vinyl modified siloxane, organo-modified siloxanes. These additives are, in aspects, dispersed through the filament, or, in alternative aspects, localized in either the filament core or filament coating. The additives are present in the range of 0. 1 to 25% of the total weight of the filament, including all values and ranges therein.

The filament 402 is then deposited on a support surface 406 layer 408 by layer 408+n in accordance with the computer numerical code to form a tooling scaffold 400. As illustrated, two passes of filament 402 are used create the wall 410 and two passes of filament 402 are used to create a scaffold cooling line 412. It should be appreciated that the number of passes of filament 402 used to form each feature of the tooling scaffold 400 may vary depending factors such as whether the tooling scaffolding 400 will remain with the tooling 200, the mechanical properties required to support the features of the tooling scaffold 300, and the mechanical properties required from each feature during use, if the tooling scaffold 400 is not removed. In aspects, in the range of 1 to 10 passes may be used to form tooling scaffold features, including all values and ranges therein, such as 1 to 2 passes, 3 to 4 passes, etc. Referring to FIG. 5, once the tooling scaffold 502 is printed, at block 112, the void volume 530 within the tooling scaffold 502 is filled with a casting material 552. The casting material 552 may be introduced into the void volume 530 through one or more openings 554 in the tooling scaffold 502. The casting material 552 takes on the shape of the inner surfaces 532, 534, 336 (not visible), 538, 540, and 541 (not illustrated) of the tooling scaffold 502 as well as the features defined by the tooling scaffold 502, such as the cooling lines 514, as well as features formed on the inner side of the forming surface 543′, etc.

The casting material 552 includes materials that are flowable and can be hardened, cured, or crosslinked, such as concrete, ceramics, thermoplastics, foam, gels such as xerogels or gelled thermosets, low melting point metals, eutectic alloys, and thermoset polymers.

Thermoset polymers include, for example, epoxy, urethanes, acrylic resins, polyesters, vinyl esters, phenolics, amino resins, furan resins, benzoxazines, and silicones. The casting material 552, in aspects, includes fillers, such as in the form of fibers, powders, particles or flakes, to relatively increase strength, hardness, thermal conductivity, lubricity, dimensional stability, machinability or combination thereof. In an aspect, the fillers include fillers susceptible to a magnetic field, electric field, or an electromagnetic field, to influence the orientation of the fillers before or during curing. In a further aspect, conductive fillers, such as metal particles, metal fibers, carbon particles, carbon nanotubes, or electromagnetic susceptors are present in the casting material 552 in an amount sufficient to provide conduction of a current, heat, or both, through the castable material 552 after curing. In aspects, these susceptible fillers may also aid in the curing process by enabling heating of the casting material with electric currents or electromagnetic energy including DC currents, radio frequency, microwave, and infrared heat.

Fibrous fillers used in casting material 552 include carbon fiber, glass fiber, metal fibers, mineral fibers, or fibers of different polymer materials having relatively higher melting points than that of the polymer forming the filament. Fibrous fillers exhibit a length in the range of 1 micrometer to 10 millimeters, including all values and ranges therein, such as in the range of 1 micrometer to 100 micrometers, 100 micrometers to 3 millimeters, etc. Powders, particles, or flake include glass, metal, cellulose, mineral, fluoropolymer, graphite, carbon, molybdenum disulfide, and ceramics such as boron nitride and aluminum nitride, as well as carbon nanotubes, wherein the powders, particles, flakes, or nanotubes have, in some aspects, a particle size of 100 micrometers or less, including nanoparticles having a particle length of less than 1. 0 micrometer. In aspects, the fillers are present in an amount of 1 percent to 95 percent of the total weight of the casting material 552, including all values and ranges therein, such as 25 percent to 90 percent, 20 percent to 50 percent, etc.

In aspects, the tooling scaffold 502 is treated prior to the introduction of the casting material 552, such as being coated in release agents or machined prior to adding the casting material 552. In additional aspects, a treatment is applied to the casting material 552 as it fills the tooling scaffold 502 or once it has been added to the tooling scaffold 502. For example, a magnetic or electrostatic field is applied to the casting material 1552 as it fills the tooling scaffold 502 or after filling the tooling scaffold 502 to orient the filler particles susceptible to such fields within the casting material 552. In further aspects, the tooling scaffold 502 is treated after adding the casting material 552, such as by vibrating the tooling scaffold 502 to assist in settling the casting material 552 and reducing air bubbles in the casting material 552 prior to hardening. In aspects, casting methods including vibration casting, vacuum casting, pressure casting, or centrifugal casting are employed herein to assist in filling the scaffold with full density, eliminating air voids, or working with high viscosity or thixotropic casting materials.

The casting material 552 hardens to form a solidified shape. In aspects, hardening is caused by a chemical reaction in the casting material, such as hydration, curing, vulcanization, or irradiation. In aspects including concrete, hardening is due to hydration, where water in the concrete mix forms chemical bonds with the cement in the concrete mix. In aspects including thermosetting polymers, hardening occurs through the crosslinking of polymer chains initiated by the addition of crosslinking agents, heat, pressure, change in pH, irradiation, or a combination thereof. Thermoplastic polymers, in aspects, are also useable as casting materials 552 and cross-linked upon exposure to irradiation such as an electron beam, gamma radiation, or light in the UV electromagnetic range.

It should be appreciated that in some aspects, such as the aspect illustrated in FIG. 5, the hollow passages 515 in the cooling lines 514 allow for the introduction of cooling or heating to manage the temperature of the casting material 652 within the tooling scaffold 502 during hardening. Thermal management may be facilitated by the introduction of gas or liquid in to the passage of the cooling lines 614 that is either hot or cool to introduce or reduce heat, respectively.

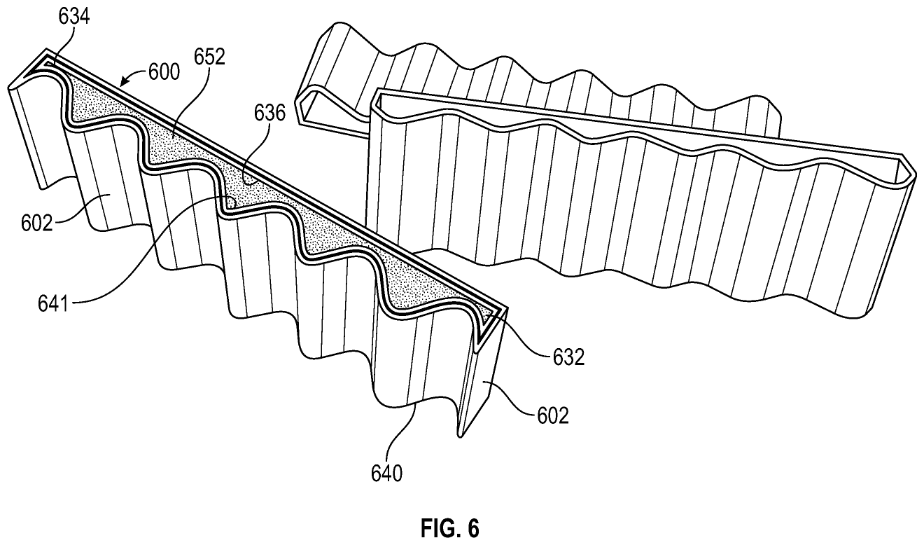

FIG. 6 illustrates an aspect of cast tooling 600, including a 3D printed tooling scaffold 602 and the hardened casting material 652, in this example concrete. As illustrated, the casting material 652 takes on the shape of the interior surfaces 632, 634, 636, 640 (not visible), and 641. While not illustrated, if baffles (see baffles 350′ of FIG. 3C) are included in the tooling scaffold 602, the baffles are at least partially and, in some aspects, completely encapsulated, by the casting material 652. Where cooling lines are present, such as illustrated in FIG . 5, the casting material 552 takes on the shape of the cooling lines 514, wherein hollow passages 515 are defined by the cooling lines 514.

At block 114, and with reference again to FIG. 5, the 3D printed tooling scaffold 502 is optionally removed from the exterior surface of the casting material 652, which itself is then used as the tooling for molding. In aspects, the tooling scaffold 502 may be removed mechanically or chemically. For example, in aspects, the tooling scaffold is removed by machining or otherwise cutting the scaffold off. In yet further embodiments, the tooling scaffold 502 is retained in the tooling. Regardless of whether the exterior surfaces 518, 520, 524, etc., of the tooling scaffold 502 are removed, the portion of the tooling scaffold forming cooling lines 514 are removed, in some aspects, or retained in other aspects.

At block 116 of FIG. 1, the tooling 500 is then optionally finished. In aspects, if cooling lines 514 are present, the cooling lines 514, which may inherently be porous, are sealed to reduce the build-up of scale, by providing an antifriction coating, or to reduce the porosity of the cooling lines 514, preventing leakage upon the introduction of a coolant. However, it should be appreciated that the casting material 552, particularly in aspects where the casting material is a polymer, seals the cooling lines 214 and an additional sealing of the cooling lines can be omitted. In aspects, and with reference to FIGS. 2A, 2B and FIG. 4, the forming surface 204 is sealed to reduce crevices 420 (illustrated in FIG. 4) that may be present on the surface between the layers 408, 408+n. In further aspects, the forming surface 204 is plated or coated with an anti-stick coating, such as nickel, chromium, or nickel-polytetrafluoroethylene, to prevent sticking of parts during molding. In additional aspects, the forming surface 204 and other exterior surfaces 218, 220, 222, 224, 226, 228 are polished or otherwise machined to reduce roughness or other undesirable features. In addition to sealants, coatings and machining, other finishing operations may be performed as well, such as tapping of the cooling lines, etc. Further, as alluded to above, the tooling 200, 500, 600 may be assembled to include additional plates, an ejector system, a heated sprue assembly or other features.

The cast tooling 200, 500, 600 is used to form parts, in processes such as injection molding, blow-molding, compression molding, roto-molding, composite lay-up, extrusion, vacuum forming, hydroforming, and casting. As noted above, the tooling includes, for example, a mold, die, jig, pattern, or fixture. In aspects, the parts are formed from thermoplastics, thermosets, woven fabrics, non-woven fabrics, or metal of various forms including sheets, pipes, or other profiles. For example, the cast tooling 500 of FIG. 5 with the tooling scaffold 502 is, in aspects, used in an injection molding process, and the cast tooling 600 of FIG. 6 after removal of the tooling scaffold 602 is, in aspects, used in a hydroforming process or for composite lay-up.

The cast tooling and method of forming cast tooling from material extrusion 3D printed scaffolds of the present disclosure offer several advantages. These advantages may include a relative reduction tooling mass and density prior to adding the casting material. These advantages may further include a relative reduction in time to print tooling and form a 3D printed tooling as compared to 3D printed tooling that is in filled with printed filament. These advantages may further include a relative reduction in cost the 3D printed portion of the tooling as compared to 3D printed tooling including 3D printed infill. These advantages may yet further include the ability to utilize relatively lower performance, less costly resins, as the 3D printed portion of the tooling is supported by relatively higher performance casting materials. These advantages may also include the reduction in the number of processing steps as the filling the tooling scaffold and sealing cooling lines can occur in a single step.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method forming tooling, comprising:
3D printing a tooling scaffold wherein the tooling scaffold defines a void volume and a scaffold forming surface;
filling the void volume with a casting material; and hardening the casting material.

2. The method of claim 1 further comprising treating the tooling scaffold prior to filling the void volume with casting material.

3. The method of claim 2 wherein treating the tooling scaffold includes machining the tooling scaffold.

4. The method of claim 2 wherein treating the tooling scaffold includes coating a release agent on the tooling scaffold.

5. The method of claim 1, further comprising applying a magnetic or electrostatic field to the tooling scaffold while filling the void volume with casting material.

6. The method of claim 1, further comprising vibrating the tooling scaffold after filling the void volume with casting material.

7. The method of claim 1, wherein the void volume is filled with casting material using a casting method selected from the group consisting of vibration casting, vacuum casting, pressure casting, and centrifugal casting.

8. The method of claim 1, wherein hardening the casting material comprises chemically reacting the casting material.

9. The method of claim 8, wherein the casting material is concrete and chemically reacting the casting material includes hydration.

10. The method of claim 8, wherein the casting material includes a thermoset and chemically reacting the casting material includes crosslinking the casting material.

11. The method of claim 8, wherein chemically reacting the casting material includes vulcanization of the casting material.

12. The method of claim 1, further comprising removing the tooling scaffold from the casting material after hardening.

13. The method of claim 1, wherein the tooling scaffold further defines scaffold cooling lines and the method further comprises introducing cooling or heating fluids or gasses into the scaffold cooling lines while hardening the casting material.

14. The method of claim 1, wherein the tooling scaffold further defines scaffold cooling lines and the method further comprises sealing the scaffold cooling lines.

15. The method of claim 1, further comprising sealing the scaffold forming surface.

16. The method of claim 1, further comprising generating a computer numerical control code from a CAD file, wherein the computer numerical control code is used in 3D printing a tooling scaffold.

17. The method of claim 16, further comprising merging a plurality of CAD files for generating the computer numerical control code.

18. A tooling formed from a 3D printed scaffold, comprising: a
3D printed scaffold;
a casting material hardened within the 3D printed scaffold; and
a scaffold forming surface defined by the 3D printed scaffold.

19. The tooling of claim 18, further comprising an auxiliary feature defined by the 3D printing scaffold, wherein the auxiliary feature includes scaffold cooling lines.

20. The tooling of claim 18, wherein the 3D printed tooling scaffold includes a plurality of baffles.
